(19) United States
(12) Patent Application Publication
(10) Pub. No.: US 2023/0061787 A1
(43) Pub. Date: Mar. 2, 2023

(54) SUSTAINABILITY FOOTPRINT DETERMINATION AND MANAGEMENT

(71) Applicant: SAP SE, Walldorf (DE)

(72) Inventors: Stefan Feickert, Birkenau (DE); Rupert Lange, Walldorf (DE); Ramana Mohanbabu, Bangalore (IN); Frank Oliver Hoffmann, Wiesloch (DE); Arkadiy Syamtomov, Munich (DE); Ranjit Alapati, Vijayawada (IN); Nisheeth Agarwal, Lucknow (IN); Swarnava Chatterjee, Varanasi (IN)

(73) Assignee: SAP SE, Walldorf (DE)

(21) Appl. No.: 17/458,159

(22) Filed: Aug. 26, 2021

(51) Int. Cl. G06Q 10/06; G06Q 30/00; G06F 16/28

(52) U.S. Cl. CPC G06Q 10/06375; G06Q 30/018; G06F 16/283

(57) ABSTRACT

Systems and processes for calculating sustainability footprints and controlling associated systems are provided herein. Activity data may be received for an organization, and emissions factors may be determined for the activity data. Absolute, relative, and/or average relative footprints may be calculated for the organization based on the activity data and the emissions factors. An indication of the absolute, relative, and/or average relative footprints may be generated for display on a graphical user interface of a computing device.

### BACKGROUND

The impact of an organization and associated operations on the environment may be tracked through the use of sustainability footprints, which may include carbon footprints, water footprints, ecological footprints, and/or other footprints. The sustainability footprints may be used to evaluate implications of strategic decisions, track progress toward sustainability goals, and ensure compliance with regulations, among other applications.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In summary, the detailed description is directed to various innovative technologies for managing, processing, and generating display information relating to data input into cartesian columns. In some examples, the disclosed technologies can be implemented as a method performed by a computer. Activity data for an organization is received, and emissions factors for the activity data are determined. Absolute and relative sustainability footprints for the organization are calculated based on the activity data and the emissions factors. Average relative sustainability footprints are calculated for the organization over a specified time period based on the absolute and relative sustainability footprints, and an indication of the absolute, relative, and average relative sustainability footprints is generated for display on a graphical user interface.

In some examples, the disclosed technologies can be implemented as computer-readable media storing instructions which, when executed by one or more hardware processors, cause the hardware processors to perform the following actions. A set of emissions factors for one or more products, materials, or suppliers of materials is retrieved. Activity data for an organization is received, the activity data including one or more categories of data relating to operations of the organization. For each category of activity data, the activity data is mapped to a respective relevant emissions factor from the retrieved set of emissions factors to generate enriched or augmented activity data. For a selected product, material, or supplier of materials, a plurality of relative sustainability footprints is calculated for the organization using the enriched or augmented activity data in association with operations of the organization in a targeted period relating to the selected product, material, or supplier of materials. An absolute sustainability footprint is calculated for the selected product, material, or supplier of materials corresponding to a sum of the plurality of relative sustainability footprints for the targeted period. An average relative sustainability footprint is calculated for the organization over a specified time period based on the absolute and relative sustainability footprints. An indication of the calculated relative, absolute, and average relative sustainability footprints is generated for display on one or more views of a graphical user interface.

In some examples, the disclosed technologies can be implemented in a system including one or more hardware processors with coupled memory, and computer-readable media storing instructions executable by the one or more hardware processors. The instructions include first, second, third, fourth, fifth, and sixth instructions. The first instructions, when executed, cause a selection of emissions factors to be used for a sustainability assessment for an organization to be received via a user interface displayed on a client computing device. The second instructions, when executed, cause activity data for the organization in accordance with one or more parameters of the assessment to be received. The third instructions, when executed, cause relative and absolute footprints to be calculated for a first time period for the activity data associated with the first time period using the emissions factors. The fourth instructions, when executed, cause relative and absolute footprints to be calculated for a second time period for the activity data associated with the second time period, where the calculation of the relative and absolute footprints for outflows of the organization use an associated relative or absolute footprint calculated for the first time period. The fifth instructions, when executed, cause an average relative footprint for the organization based on the calculated relative and absolute footprints to be calculated. The sixth instructions, when executed, cause an indication of the calculated average relative footprint for the organization to be output to one or more applications of the system for adjusting operations of the system to reduce an overall footprint associated with the organization.

The foregoing and other objects, features, and advantages of the invention will become more apparent from the following detailed description, which proceeds with reference to the accompanying figures.

### BRIEF DESCRIPTION OF THE DRAWINGS

FIG. 1 is a block diagram of an example system for calculating sustainability footprints.

FIG. 2 is an example environment for which sustainability footprints may be calculated.

FIG. 3 is an example of an output of sustainability footprint calculation results.

FIG. 4 is a flowchart of an example method for calculating and outputting sustainability footprints.

FIG. 5 is a diagram of an example computer architecture for a system in which sustainability footprints may be calculated.

FIGS. 6-8 show example user interfaces that may be used to configure and view output of a sustainability footprint calculation.

FIG. 9 is a diagram schematically depicting a computing environment suitable for implementation of disclosed technologies.

FIG. 10 is a diagram schematically depicting computing devices operating in conjunction with a computing cloud for implementation of disclosed technologies.

### DETAILED DESCRIPTION

### Introduction and Overview

Sustainability services may utilize efficient and fast algorithms for sustainability footprint (e.g., a carbon CO₂ footprint) calculations. These calculations may be related to individual value chain contributions of upstream processes like raw material processing and inbound transport, own processing like production or assembly of products, and downstream processes like outbound transport, product use, and product end of use. The calculated footprints may be used as a data basis for reducing direct or indirect emissions, and with that to reduce costs like carbon taxes. The scope of such footprint calculations is defined but not limited to the scopes defined by the Greenhouse Gas Protocol (GHG Protocol). These calculation algorithms are configured to cover the complex cases like multiple suppliers in upstream inbound activities, the accumulation of goods in the inventory, the supplier-unaware outbound flows in direct production, the downstream activities etc. The calculations may be based on various types of so-called Business Activity Metrics (BAM) like physical goods movement, extracted from business data sources. This data, being accumulated and aggregated in a defined way, combined with the sustainability reference factors (which are obtained from external and home systems in the form of sustainability impacts for various business activities), form the basis for corporate business activities footprint calculations. These results may then be used as a basis for sustainability scoring and footprint determination in general business processes like purchasing, material sourcing, production planning and optimization, Material Requirements Planning (MRP) and vendor selection, etc. and used for broader analytical reporting, including creation of a respective sustainability factors base.

This disclosure describes a new approach including the application of a calculation algorithm based on periodic averages, which enables fast and efficient calculations of footprints of products. The described approaches may combine related big-data real-time Business Activity Metrics, which are retrieved from Enterprise Resource Planning (ERP) systems (such as S/4HANA ledgers) with sustainability reference factors provided by external parties (such as the supplier, third party, and/or public databases). The described technologies may also define an approach to determine and calculate the error rate and accuracy taken into the account as consequence of working with averages for gaining high calculation performance. The new proposed calculation approaches described herein may be generic and/or agnostic with regards to specific industries or business sectors. In addition to a generic calculation algorithm, a generic business configuration scheme is described herein based on Assessment Templates and Derivation definitions.

The disclosure addresses the problem to make the above-described footprint calculations clear, consistent, logical, memory and time efficient based on a new concept based on periodic averages. It offers reasonable approximations and describes various methods, which make the calculations transparent for users and gives formulas and processes for estimations of calculation method related errors.

### Example System

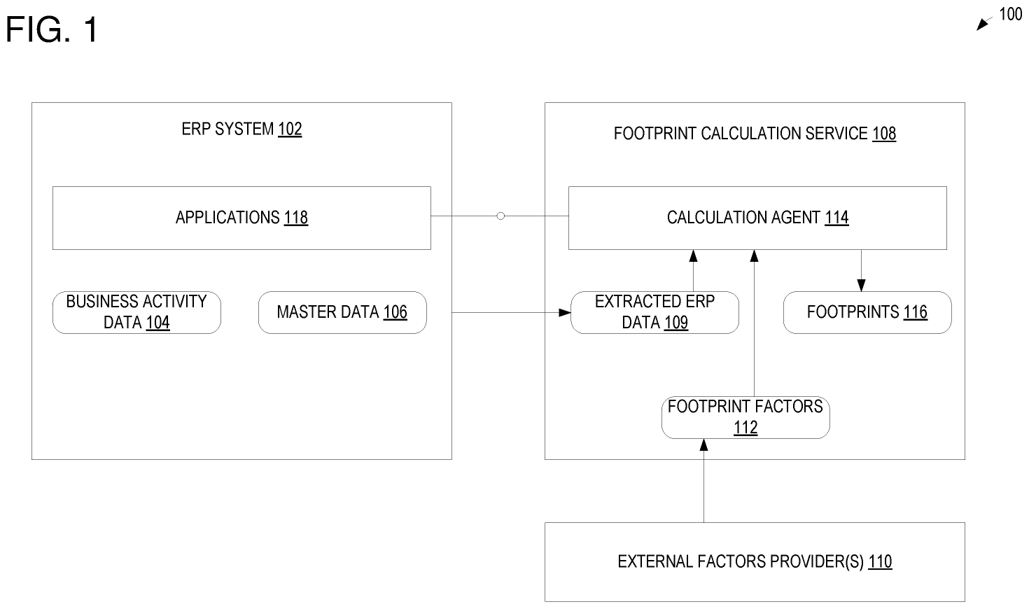

FIG. 1 shows an example block diagram of a system 100 for calculating sustainability footprints for an organization. The usual business process flow for product-centric industries in an ERP system 102 start with material procurement from various suppliers based on periodic planning or ad hoc requests due to business needs. This is an elaborate process which is executed by either a strategic purchaser or by an operational purchaser. Once the raw materials are received from the designated suppliers into the chosen plants, an inventory is maintained by posting a goods issue. Production processes then consume the raw materials as per predefined bill of materials (BOMs) and recipes (production process definition) and produce finished products which can then be further used in business processes including sales and distribution to end consumers. All related input and output data are stored in an ERP system (or associated services like a master data integration service).

In an initial stage, the described approach includes a new journey starting with extracting the data (e.g., business activity data 104 and/or master data 106) out from the ERP system 102 and loading it into a footprint calculation service 108 (e.g., into an extracted ERP data storage 109). However, getting the detailed single-line item data from service-level systems, though accurate, may be a cumbersome process with regard to data volume, network bandwidth and CPU load, which eventually is inefficient and sometimes impossible for long-periodic footprint calculations. Therefore, the disclosed process includes aggregating the detailed business data at a periodic time interval (for example weekly, monthly, yearly, etc.) in a specific way and then use the periodic aggregated data for periodic calculations.

In a second stage, reliable calculations for footprint calculations utilize reliable sustainability reference content, which may include external data, provided by data providers (e.g., external factors providers 110) gathering it from other sources or by business partners like the suppliers into a footprint factors database 112. The sustainability content is industry standard data which gives details of the environmental impact based on different parameters like carbon impact or water impact for a specific material depending on certain factors like for example country of origin. An example is the footprint factor, such as 1.1 kg CO2e for 1 kg sugar. The choice of the content provider depends on the customer and can be decided on variety of parameters like diversity of data, reliability of data, accuracy of data etc. This decision also depends on the sector, industry, or the nature of business that the customer operates in. Supplier's footprint factors may be included by standard formats and APIs. Therefore, in a third stage of operation, the content data (e.g., the extracted ERP data 109 and footprint factors 112) is imported into a calculation agent 114 of the calculation service in a standardized way.

In a fourth operation, the calculation service utilizes the footprint calculation agent 114, which is able to determine the appropriate footprint derivation, which includes the business input data, the selection of the appropriate sustainability reference content (e.g. footprint factors), and the calculation algorithm based on a given business scope. Once this derivation is determined, the calculation can be scheduled as assessment run. In some examples, the calculation may be performed at regular intervals automatically based on a schedule set by a user and/or based on one or more triggering events (e.g., an initiation of a new procurement process). The calculation agent may employ a coded calculation algorithm, which is specified in more detail below.

Once the assessment run has been executed and the footprint calculation algorithm has computed a set of footprints, those footprints are stored into a footprints database 116, which may include a multidimensional data cube in some examples. The footprint sets may have business object types and time as dimensions. Business object types in scope for the implementation but not limited concept-wise are supplier, plant, product (group). An in-memory column data base, such as SAP HANA Cloud, may be used as footprint persistency, however simpler database approaches can be chosen, too, with the drawbacks of lower performance.

After the footprints are calculated, they can be used in applications 118 of the ERP system 102 for optimizing business processes like reducing the footprint of inflow materials (purchasing and sourcing), the production process (manufacturing and maintenance) or transport (logistics).

### Example Environment

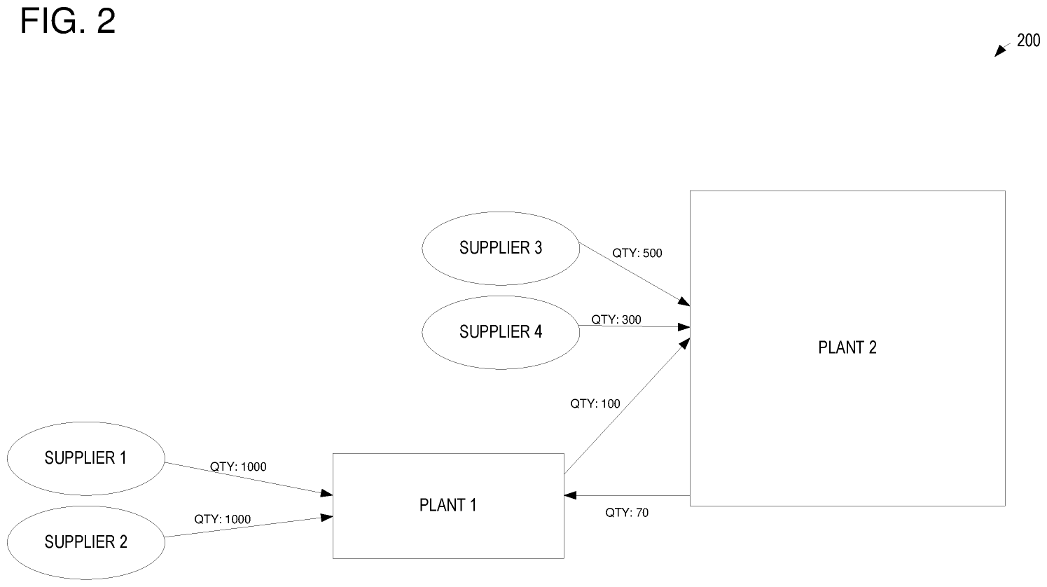

A simplified calculation example of sustainability footprint determinations is given in this section. It relates to an abstract and simplified material flow with 4 raw material suppliers and 2 plants of an enterprise 200 structured as shown in FIG. 2.

Plant 1 and plant 2 produce the same arbitrary end-product for a company. They utilize just one and the same raw material for this product. The raw material is shipped by supplier 1 and 2 to plant 1 and by supplier 3 and 4 to plant 2. Plant 1 and plant 2 exchange this raw material from time-to-time, which introduces a circular delivery situation, which happens in the worst case in the same calculation period. For breaking the circular dependency (which would lead into an endless calculation which might not converge to a target value), the calculation scheme proposes a recursive approach, based on periodic averages, where the outflows (can be raw materials or products) be calculated based on the previous period's relative footprint factor. In the given example, the plant 1 and plant 2 circular shipments may not be consolidated by, for example, a reverse posting. In other examples, the circular shipments are consolidated, and the algorithm works in the same way with the consolidated posting.

### Example Footprint Calculation Output

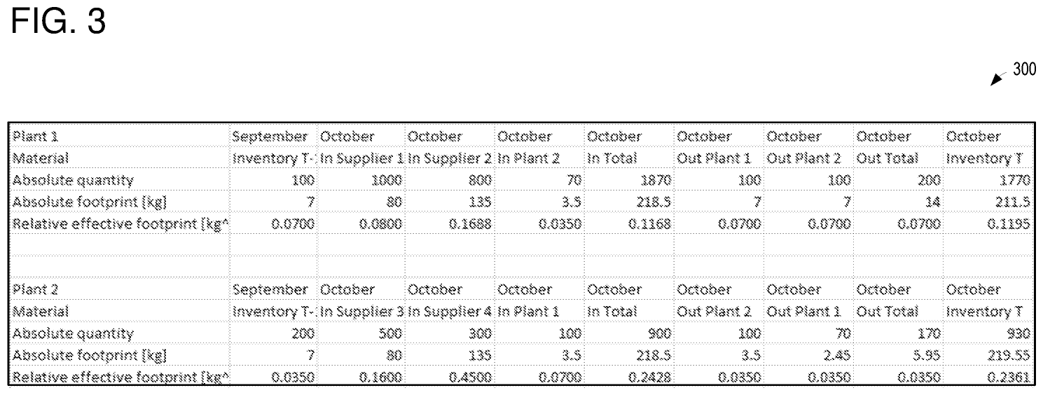

FIG. 3 is an example output 300 of a sustainability footprint for the environment shown in FIG. 2. For example, the output 300 may be presented in a graphical user interface of a client device, such as a device associated with an ERP system (e.g., ERP system 102 of FIG. 1) responsive to performing a calculation using a footprint calculation service (e.g., footprint calculation service 108 of FIG. 1). For the calculation time dimension, two periods are chosen, September and October. The September calculation has happened before, the values are available (recursive calculation may be performed if not yet available). Plant 1 and plant 2 have the values “on-stock” as depicted in the 2nd column “Inventory T−1”. The first row contains the absolute quantity of the raw material in a base unit e.g. kg, the second row the absolute footprint of the raw material in kg and the third the relative footprint factor in 1/kg or kg/kg respectively.

In October, plant 1 gets delivered 1000 kg by supplier 1 and 800 kg by supplier 2 with their specific relative footprint factors 0.08 and 0.1688 respectively, which have been exchanged as sustainability content before (e.g., as described above). From plant 2, plant 1 receives 70 kg as reverse inflow with the relative footprint of plant 2 of the previous period (0.035). In the same period October, plant 1 uses 100 kg and ships 100 kg to plant 2, both with the relative footprint plant 1 had calculated for the previous period September (0.07). This is also the relative footprint “given” to plant 2, which breaks the circle of calculation.

For plant 2, the analogues calculation happens: It gets delivered 500 kg by supplier 3 and 300 kg by supplier 4 with the factors 0.16 and 0.45. From plant 1, plant 2 receives 100 kg as inflow with the relative footprint of plant 1 of the previous period (0.07). In the same period October, plant 2 uses 100 kg and ships 70 kg to plant 1, both with the relative footprint plant 2 had calculated for the previous period September (0.035). This is also the relative footprint “given” to plant 1, which breaks the circle of calculation.

### First Example Method

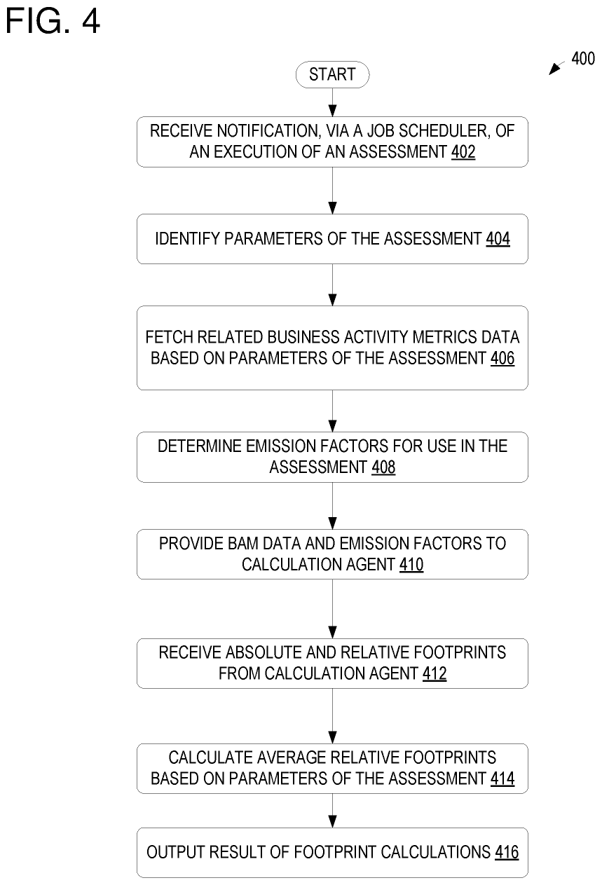

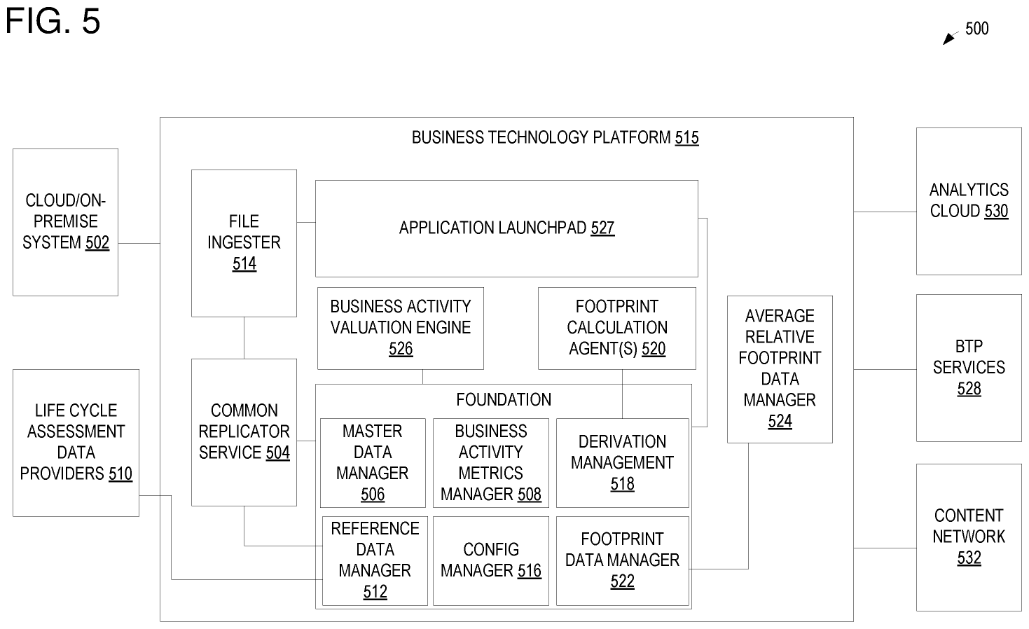

FIG. 4 is a flowchart of an example method 400 for illustrating a process sequence of calculation components and microservices. For example, method 400 may be performed by one or more components of a system, such as system 100 of FIG. 1 and/or system 500 to be described below with respect to FIG. 5. At 402, the method includes receiving a notification, via a job scheduler, of an execution of an assessment. For example, a Business Activity Value Engine (BVE) may be periodically (e.g., monthly) notified via Job Scheduler service on a Business Technology Platform (BTP) to execute an Assessment. As noted above, examples of the platforms, engines, and other elements of the system used to execute the method are described in more detail below with respect to FIG. 5.

At 404, the method includes identifying parameters of the assessment. For example, the BVE may retrieve the assessment definition to identify the period, the business scope (e.g., corresponding to master data and Business Activity Metrics [BAM] data), and/or the footprint categories to be calculated along with the related derivation definitions to be used to calculate footprints.

At 406, the method includes fetching related business activity metrics data based on parameters of the assessment. At 408, the method includes determining emission factors for use in the assessment. For example, a Business Activity Valuation Engine may orchestrate the calls for each period, for each footprint category, for each business activity category combination for absolute and relative footprints calculation by invoking a Derivation Management module. The Derivation Management module may use an orchestrator to fetch the related BAM data based on business scope and period for all the Goods Movement which are received from a supplier. A Business Activity Metrics Data Manager may fetch related BAM data which is enriched or augmented with Master data. For example, the BAM data may be enriched or augmented by providing additional details to the BAM data, such as supplier and/or plant country and/or other information associated with a supplier and/or plant indicated in the BAM data, product details such as gross weight, net weight, volume, density, and/or other attributes for one or more products referenced in the BAM data, etc. The Derivation Management Orchestrator provides the enriched or augmented BAM data to Determination Engine to find most suitable Sustainability Reference Content data using the determination algorithm and the business data.

At 410, the method includes providing the BAM data and the emission factors to a calculation agent, which calculates absolute and relative footprints based on the BAM data and emission factors. The method further includes receiving the calculated footprints at 412. For example, the Derivation Management Orchestrator may provide the BAM data along with determined emission factors to a Calculation Agent, which returns the absolute and relative footprints for the BAM data and these derived footprints are handed over to a Footprint Data Manager, which are then persisted. The Orchestrator then acknowledges back the status of calculation to the Business Valuation Engine.

At 414, the method includes calculating average relative footprints based on the parameters of the assessment. For example, after all the calculations are acknowledged by the Derivation Management to the Business Activity Valuation Engine and on all successful derivations the Business Valuation Engine then triggers the calculation of Average Relative footprints by invoking Footprints Data Management for each period and business scope definition defined in the assessment. The Footprint Data Manager then triggers the calculation of relative, absolute footprints for all inflows which are not supplied by a Supplier and for all the outflows, and additionally the average relative footprints for all inflows and outflows of Goods Movement data, which are also persisted in the Footprint Data Manager and acknowledged back to BVE with relevant status.

BVE then updates the overall status of the assessment execution based on the acknowledgements from the Derivation Management and the Footprint Data Manager. At 416, the method includes outputting the result of the footprint calculations (e.g., the average, relative, absolute, etc. footprints and/or related data). For example, the result may be output to a graphical user interface and/or output to a downstream process or system for controlling operations associated with the organization. As a non-limiting example, the calculated footprint may be provided in in a procurement user interface to inform a user of the footprint associated with one or more options for fulfilling an order for a product, which may allow a user or an associated automated procurement process to select a supplier/vendor or otherwise make purchasing decisions based on an estimated footprint calculated as described herein. In additional or alternative examples, the calculated result may be fed back into the system to be used for future calculations. Still further examples of applications for the calculated footprints includes creating integrated financial and sustainability enterprise reports, which may include product footprint statistics (e.g., footprint per product group, sales region, etc.), communicating the footprint to customers/consumers of delivered products (e.g., to assist in calculating their own footprints), and/or running analytic assessments on product footprint data by using machine learning algorithms to identify trends, outliers, and/or other features of the data.

### Example Architecture

FIG. 5 shows an example computer architecture of a system 500 that may be used to implement the technologies described herein. A cloud or on-premise system may act as a source system for the data described herein. The data used by the system may include Master/config data (e.g., company code, product, suppliers, etc.), where snapshots of this data are replicated by Common Replication Service (CRS) 504 into target persistence for a master/config service known as Master Data Manager (MDM) 506. The data may also include aggregated business activity metrics data (e.g., production orders, goods movement documents, etc.), where periodic delta/changes of these data are replicated by Common Replication Service (CRS) into target persistence for Business Activity Metrics (BAM) Data Manager service 508. As protocol for the replication, Open Data Protocol (OData) may be selected in some examples. In an exemplary implementation, CRS uses the public OData endpoints exposed by an ERP system, such as S/4 HANA, and along with Cloud Data Integration (CDI) views as OData endpoints, where these CDI views (either reused existing views or views created specifically for PFM use cases) are used for extracting master data and BAM data.

Lifecycle Assessment (LCA) data providers 510 provide the emission factors data as Sustainability Reference Content for products which are extracted, transformed and persisted in a reference format in a Sustainability Content Manager of Reference data manager 512. Customers of PFM can also bring in the reference emission factors data (Sustainability Reference Content) in a reference format and upload this data via File Ingestor (FI) service 514 of a business technology platform 515. The same mechanism can be applied for the supplier's reference emission factors.

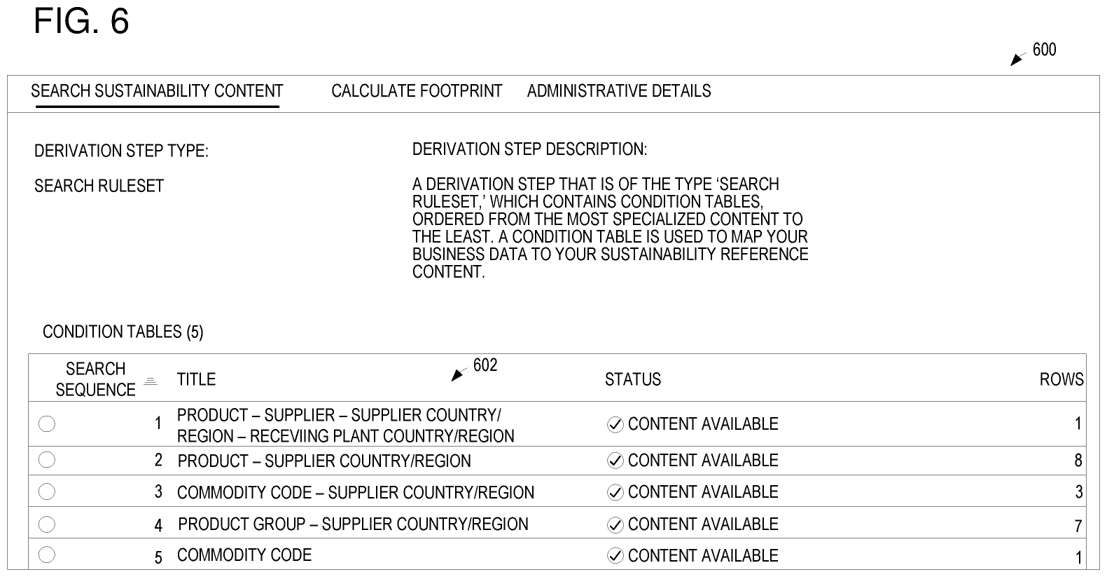

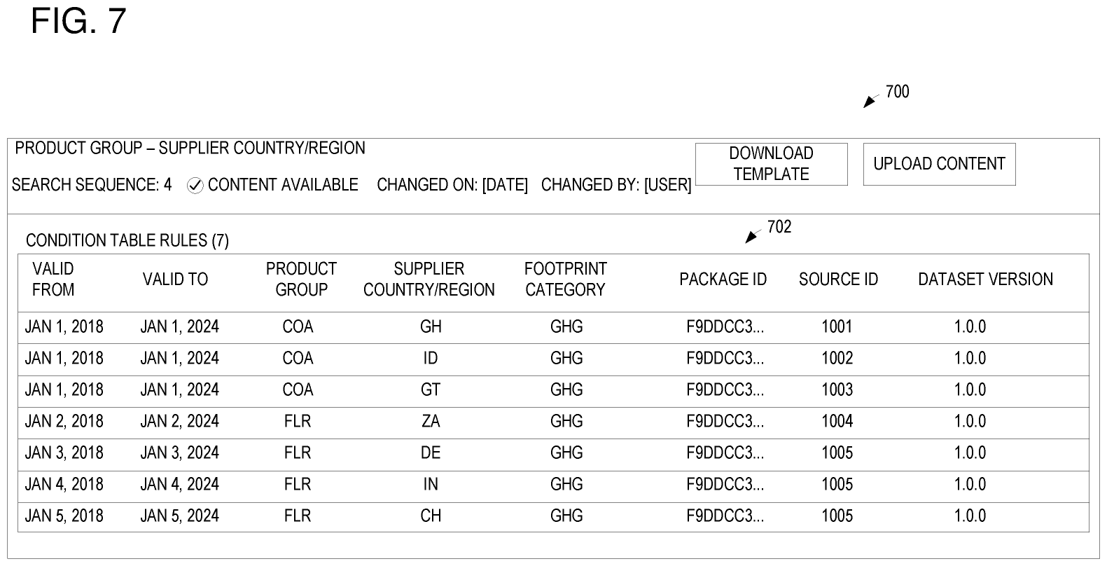

Turning briefly to FIG. 6, an example user interface 600 showing available sustainability content, which may be selected for use or further configured for use in footprint calculations. The user interface 600 includes multiple tables 602 corresponding to sustainability reference content (e.g., reference emission factors data) for different granularities. In the non-limiting illustrative example, a table representing a highest level of granularity is shown first, where the sustainability reference content for a specific product, supplier, supplier country/region, and receiving plant country/region is provided, followed by a table representing a next highest level of granularity, where the sustainability reference content for a specific product in a supplier country/region is provided, and so on. The content for each of the tables represented in user interface 600 may be defined by a user and/or provided by a supplier or other third-party system. In some examples, the content for related tables may be updated subsequent to a footprint calculation based on the results of the calculation. FIG. 7 shows an example user interface 700 displaying one of the tables referenced at 602 in FIG. 6 (e.g., the “Product Group—Supplier Country/Region” table). As shown, the table specifies package IDs 702 indicating a reference for locating sustainability information (e.g., emissions factors) for the associated product group, supplier country/region, and footprint category. Accordingly, when performing a footprint calculation, the package ID of the table selected by the user (in the user interface 600 of FIG. 6) is used to retrieve emissions factors for the product group, supplier country/region, and footprint category associated with that calculation. For example, if the user sets up (e.g., via a user interface providing selectable or otherwise editable fields for specifying parameters) an assessment for which a footprint is to be calculated for cocoa originating from a supplier in Ghana, and the user is interested in climate change-related footprint calculations, the system would utilize the first package ID in the list to retrieve the relevant emissions factors to use in the calculation. If the user were instead or additionally interested in footprint calculations for the same product and footprint category in a different country/region—India in this illustrative example—the system would instead or additionally retrieve the emissions factors for the second package ID in the list of FIG. 7 in order to perform that portion of the footprint calculation. The content of the packages corresponding to the respective package IDs may be entered, imported by the user (e.g., from a data source), and/or predefined by the system.

Returning to FIG. 5, a Configuration Manager service 516 manages all the application, system, and customer defined configuration data such as Footprint Categories, Assessment definitions and so on. A Derivation Management 518 manages the definition of derivations as design time artifacts and it also has an Orchestrator which is runtime for execution of derivation which involves a Determination Engine which finds a best match of emission factors based on the user defined search criteria for the business data and Derivation Engine which orchestrates the different Calculation Agents with all the requested data fetching and sequencing different calculations.

Calculation Agents 520 are the services which executes the calculation/derivation algorithms on the data provided as input and outputs the relative and total footprints. A Footprint Data Manager (FDM) 522 is the repository for all kinds of footprints calculated by different calculation agents and the footprints can be visualized in a ‘View Product Footprints’ application. An Average Relative Footprint Data Manager service 524 is built for calculating the Average Relative footprints.

A Business Activity Valuation Engine (BVE) 526 is the Orchestrator service which executes an assessment for a period based on business scoping like master data and BAM data, on footprint scope like CO2e to derive relative, total and average relative footprints by derivation management service and average relative footprint data manager services. A Foundation Umbrella service manages database access and the DB artifacts per tenant which is shared by foundation services like Master Data, FDM etc. An application launchpad 527 may be used to launch various application of the business technology platform, such as uploading business data, managing assessments, managing deviations, managing configurations, viewing product footprints, defining business scoping, viewing product footprint analytics, etc.

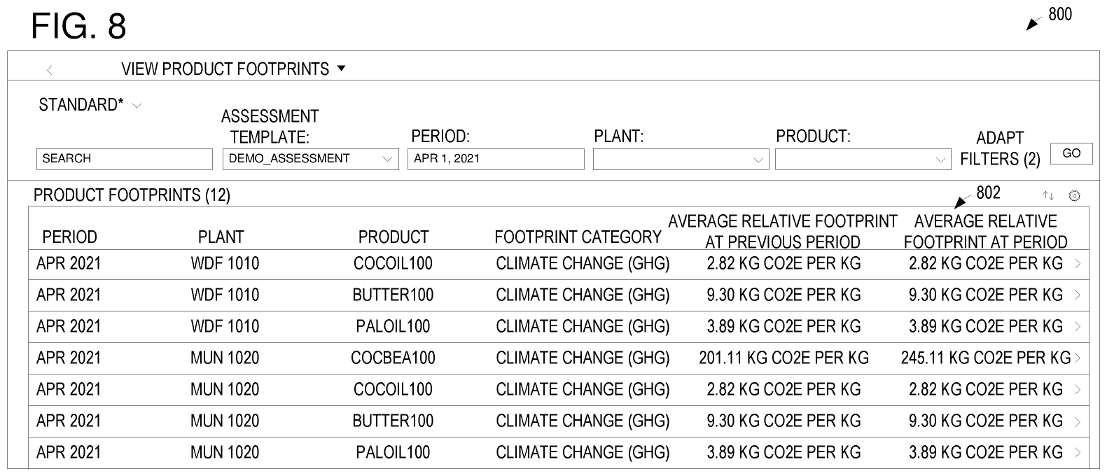

Turning briefly to FIG. 8, an example user interface 800 shows a non-limiting example of an output of a table 802 of footprint calculations performed by the system 500, as displayed to a user after the assessment is performed. As shown, the user interface 800 shows average relative footprints for a current period and for a previous period of interest, and the calculations are shown for different products/plant mappings. The user may filter the table by providing parameters including a query string, assessment template of interest, period of interest, plant of interest, product of interest, etc. Additional details of a given footprint calculation or product/plant pairing may be viewed by selecting an associated line of the table 802. Example additional details of the calculations may include inflow, outflow, and inventory levels and associated respective relative footprints.

Returning to FIG. 5, BTP services 528 may be used to realize features, such as:

Application, Audit, and Business Logging services, which are used to handle the related logging operations for tracing, auditing and business logs. An ERP Cloud may be used as a persistent storage for data and an Object Store service may be used for handling objects like zip files, CSV files, and so on.

Personal Data Manager and Retention Manager, which are used to handle the Data Privacy and Data lifecycle management related features.

Identity Provider Service (e.g., for user and role management), which is used for authentication and authorization.

SaaS Provisioning for tenant provision and deprovision features.

Analytics Cloud 530 is used for analytical reporting for slicing and dicing the footprints data with related business data for insights on footprints An ERP Integration component in an ERP system may act as a cache for footprints which can be accessed via APIs and the related UIs and also enables Line-of-Business (LoB) applications like Purchase Order to integrate footprints data for the products. A Content Network 532 includes a network of companies that can publish/consume the calculated footprints by trusted companies.

### Further Implementation Examples

This disclosure puts the calculation idea explained with the example above into a set of mathematical formulas, which are implemented as calculation agent in the calculation service. This chapter deducts the formula for the calculation of absolute and relative footprint as well as the related error rate which can happen in a period T due to the periodic averages that are used. It can be shown that the error in total converges to zero over total time.

The following constraints may be observed in some example implementations: 1. The following mathematical formulas are defined for the unit of measure dimension of mass with kg as unit. It can be applied for any dimension and any unit by exchanging the parameters with mass unit by parameters with another unit, e.g., volume. Alternatively, other units are calculated into mass by an appropriate unit of measure conversion, e.g., with density as conversion rate. 2. The following mathematical formulas are defined for a given organizational unit of an enterprise, e.g., a plant or a storage location like a warehouse. An enterprise usually has multiple organizational units for which the calculations may be run separately per each (see also example above).

(1) Cⁿ is the n-th material out of N used in production processes with a constant mass mⁿ across time (t=0 . . . ∞) and supplier (i.e., if mass changes, a new material is created).

(2) Each supplier s out of Lₜ has for period t the proper sustainability factor fₜₛⁿ. If the supplier factor is unknown, a factor fₜⁿ can be applied (e.g., for initial load/bootstrapping). If the factor for a period t is not known, a general factor fⁿ is the last default. Factors are retrieved from external factor data bases.

(3) uₜₛⁿ is the received quantity of material Cⁿ in the period t from supplier s (also called input or inflow). Suppliers can be external (i.e., vendors) or internal (i.e., own plants or warehouses).

(4a) w_{tc}ⁿ is the quantity of material Cⁿ in the period t, which is consumed in a production step or shipped to a consumer c out of Vₜ (also called output or outflow).

(4b) wₜ₂ₛⁿ is the consumed or shipped quantity of material Cⁿ from supplier s at the period t2 in a production step or to a consumer. It might be that the consummation wₜ₂ₛⁿ of the received material uₜₛⁿ happens in the same period (t2=t), in a later period (t2>t), or in partitions across multiple periods uₜₛⁿ=Σₜᵥ₌ₜ^{t2}w_{tv s}ⁿ.

(5a) Absolute quantity of Cⁿ at end of period T≥1 is:

$${R}_{T}^{n} = {R}_{0}^{n} + {\sum }_{t = 1}^{T} ( {\sum }_{s = 1}^{{L}_{t}} {u}_{ts}^{n} - {\sum }_{c = 1}^{{V}_{t}} {w}_{tc}^{n} )$$

With R₀ⁿ as quantity at begin (initial load/bootstrapping) point in time.

(5b) To minimize data volume, the quantity is calculated recursively:

$${R}_{T}^{n} = {R}_{T - 1}^{n} + {\sum }_{s = 1}^{{L}_{t}} {u}_{Ts}^{n} - {\sum }_{c = 1}^{{V}_{t}} {w}_{Tc}^{n}$$

This allows to delete all single data points uₜₛⁿ and w_{tc}ⁿ after the calculation which reduces allocated volume on DB drastically. The calculation itself is much faster than (5a) since computing sums across all data is avoided.

(6) Absolute quantity in mass of Cⁿ at end of period T is: S_{T}ⁿ=R_{T}ⁿ*mⁿ.

(7a) Absolute footprint of material Cⁿ in the stock is the sum of all individual footprints for periods t:

$${I}_{T}^{n} = {I}_{0}^{n} + {\sum }_{t = 1}^{T} {\sum }_{s = 1}^{{L}_{t}} ( {u}_{ts}^{n} * {m}^{n} * {f}_{ts}^{n} ) - {\sum }_{t 2 = 1}^{T} {\sum }_{s = 1}^{{L}_{t}} ( {w}_{t 2 s}^{n} * {m}^{n} * {f}_{ts}^{n} )$$

with I₀ⁿ=S₀ⁿ*f₀ⁿ=R₀ⁿ*mⁿ*f₀ⁿ (which is initial load/bootstrapping at T=0). Note that for outflows wₜ₂ₛⁿ the factors fₜₛⁿ at the point of inflow is to be taken.

(7b) As in (5a), (7a) includes keeping all historic single data points and their relation in time. Second, run sum operation across all data points is necessary, which is CPU and memory intensive. Therefore, the concept of “periodic averages” is introduced, which defines a relative footprint factor Fₜⁿ so that:

$$\begin{matrix}{I}_{T}^{n} = {I}_{T - 1}^{n} + {\sum }_{s = 1}^{{L}^{t}} ( {u}_{Ts}^{n} * {m}^{n} * {f}_{Ts}^{n} ) - {\sum }_{c = 1}^{{V}^{t}} ( {w}_{Tc}^{n} * {m}^{n} * {F}_{T - 1}^{n} ) \\ = {I}_{T - 1}^{n} + {m}^{n} * ( {\sum }_{s = 1}^{{L}^{t}} ( {u}_{Ts}^{n} * {f}_{Ts}^{n} ) - {F}_{T - 1}^{n} * {\sum }_{c = 1}^{{V}^{t}} {w}_{Tc}^{n} )\end{matrix}$$

As in (5b), such a recursive approach with relative footprint as average factor allows to delete the data points uₜₛⁿ, wₜ₂ₛⁿ, and fₜₛⁿ after the calculation, which reduces the allocated DB volume drastically. Again, the calculation itself is much faster than (7a) since computing sums across all data is avoided.

(8) Fₜⁿ is the relative footprint of material Cⁿ at the end of period T≥1 with:

$${F}_{T}^{n} = \frac{{I}_{T}^{n}}{{S}_{T}^{n}}$$

From an algorithm perspective, first R_{T}ⁿ and I_{T}ⁿ are calculated, then F_{T}ⁿ, so this relative footprint is used for the calculation of the next period.

A consumer c of an outflow can be supplier s of an inflow in a period T for the same material Cⁿ and for the same organizational unit (e.g., plant1 ships Cⁿ to plant 2 and plant2 retours Cⁿ to plant1 in T). This leads to the circular calculation problem, because F_{T}ⁿ of plant1 and plant2 are usually different. Therefore, the calculation of (shipped) outflows in (7b) are done with the relative footprint F_{T-1}ⁿ of the previous period. This leads to an approximation error if E_{c=1}^{v}^{^{t}}w_{T c}ⁿ>R_{T-1}ⁿ with

$${w}_{T err}^{n} = {\sum }_{c = 1}^{{V}^{t}} ( {w}_{Tc}^{n} ) - {R}_{T - 1}^{n}$$

(Otherwise it is w_{T err}ⁿ=0).

(10) In this case, the quantity w_{T err}ⁿ is consumed/shipped with F_{T-1}ⁿ though it should be F_{T}ⁿ. For the extreme case of (R_{T-1}ⁿ=0)∧(F_{T-1}ⁿ=0) (i.e., stock is empty at end of T−1), the footprint of the complete outflow is erroneously zero:

$${I}_{T out}^{n} = {\sum }_{c = 1}^{{V}^{t}} ( {w}_{Tc}^{n} * {m}^{n} * {F}_{T - 1}^{n} ) = 0$$

(In this case, this should be corrected by fallback to a standard factor (e.g. from an emission data base for the material) F_{T-1}ⁿ=f₀ⁿ).

(11) Therefore, the systematic error of this approach can be quantified with

I_{T err}ⁿ=w_{T err}ⁿ*mⁿ*(F_{T}ⁿ−F_{T-1}ⁿ)

With I_{T err}ⁿ being the absolute footprint error for outflows. A sensible error rate is relating the error to the outflows:

$$err [ \% ] = \frac{{I}_{T err}^{n}}{{I}_{T out}^{n}} * 100$$

(12) Though this systematic error leads to wrong relative footprints (which are factors from consumer point of view) downstream, it averages out in total in the next period, since the absolute footprint remaining is distributed on the remaining quantity:

Delta of absolute footprint, which is erroneously kept in stock is negative or positive depending whether the footprint of received material is greater or smaller than the footprint of material in stock:

F_{T}ⁿ>F_{T-1}ⁿ→I_{T err}ⁿ>0, i.e., the absolute footprint on stock too high by I_{T err}ⁿ

F_{T}ⁿ<F_{T-1}ⁿ→I_{T err}ⁿ<0, i.e., the absolute footprint on stock too low by I_{T err}ⁿ

(13) This will be corrected by the new calculation of

$${F}_{T}^{n} = \frac{{I}_{T real}^{n} + {I}_{T err}^{n}}{{R}_{T}^{n}} = {F}_{T real}^{n} + {F}_{T err}^{n}$$

So that

I_{T+1 out}ⁿ=Σ_{c=1}^{v}^{^{t}}(w_{T+1c}ⁿ*mⁿ*F_{T}ⁿ)=Σ_{c=1}^{v}^{^{t}}(w_{T+1c}ⁿ*mⁿ*F_{T real}ⁿ)+Σ_{c=1}^{v}^{^{t}}(w_{T+1c}ⁿ*mⁿ*F_{T err}ⁿ)

I.e., the error is eliminated from stock by being forwarded in the next period to the outflows.

Though on total average the error is eliminated, it might happen that for certain consumers slightly wrong footprints are forwarded. Therefore, it is possible to calculate and quantify the error rate as defined in (11) so that the accuracy level for the calculation can be quantified.

Accordingly, the algorithms described above may be summarized as a combination of:

1. Recursive calculation of quantities of materials (products) relevant for sustainability footprint calculation (see formula (5b))

2. Introduction of relative footprint factors following the concept of periodic averages as defined in formula (7b)

3. Derivation of a formula and calculation of quantified error values that document the accuracy of the calculation scheme (formula (9) and (11))

4. Proof that the systematic total error of the calculation is eliminate by average across periods (formula (13)).

### Example Advantages

The solution provided by the technologies described herein is superior in comparison of approaches in the past with regards to at least the following considerations.

1. The mathematical foundation provides a clear, consistent and re producible calculation model with very low adoption efforts and time to value. The solution provides a clear guidance how to map primary and secondary Sustainability Reference Content dataset with customer enterprise business data to derive Footprints.

2. The calculation can be used for all industries and organizations that have inventory management and material flow in place.

3. The technologies described herein enable customers to calculate footprints at scale and periodically using transactional “realtime” (ERP) business data.

4. Because it works with real-time transaction data from ERP systems, the calculation result has the same quality as the related material ledger inside the ERP system. Manual data copying, modifications, manual interactions and alike are avoided.

5. The technologies described here provide flexible derivation definitions to associate reference content automatically and intelligent to the business data.

6. The generic definition of business scope by Assessment Template and selection of derivation variants allow to extract the input data in an aggregated way. With that the resource consumption (e.g., with regard to memory, network bandwidth, CPU load, etc.) is reduced and the performance (e.g., duration of calculation) is increased.

7. The calculation itself can be implemented as stored procedure directly on databases, like SAP HANA Cloud. With that a high-performance calculation is possible.

8. The formula and algorithm allow a quantification of transient error rates, which are inherent for periodic averages. However, as mathematically proven, the total error over total time and supplier, plant, and consumer nodes do converge to zero.

9. The resulting calculated footprint of products can be used further in many applications like sustainability scoring of suppliers for consideration in procurement, selection of low-carbon transport logistics, reduction of costs introduced by carbon taxes and certificates.

### A Generalized Computer Environment

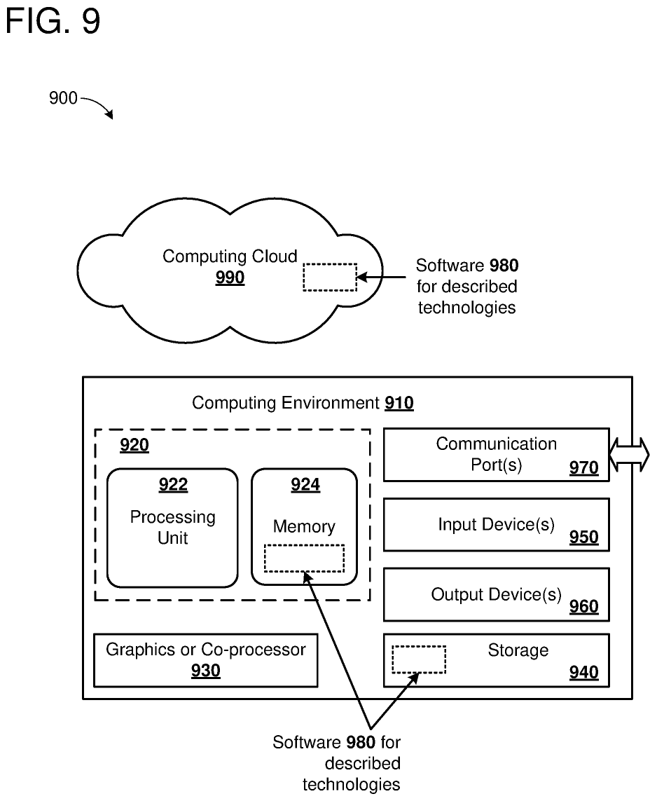

FIG. 9 illustrates a generalized example of a suitable computing system 900 in which described examples, techniques, and technologies, including calculating sustainability footprints according to disclosed technologies can be implemented. The computing system 900 is not intended to suggest any limitation as to scope of use or functionality of the present disclosure, as the innovations can be implemented in diverse general-purpose or special-purpose computing systems.

With reference to FIG. 9, computing environment 910 includes one or more processing units 922 and memory 924. In FIG. 9, this basic configuration 920 is included within a dashed line. Processing unit 922 executes computer-executable instructions, such as for implementing any of the methods or objects described herein for performing queries on a composite graph data structure representing a dynamic system, or various other architectures, components, handlers, managers, modules, or services described herein. Processing unit 922 can be a general-purpose central processing unit (CPU), a processor in an application-specific integrated circuit (ASIC), or any other type of processor. In a multi-processing system, multiple processing units execute computer-executable instructions to increase processing power. Computing environment 910 can also include a graphics processing unit or co-processing unit 930. Tangible memory 924 can be volatile memory (e.g., registers, cache, or RAM), non-volatile memory (e.g., ROM, EEPROM, or flash memory), or some combination thereof, accessible by processing units 922, 930. The memory 924 stores software 980 implementing one or more innovations described herein, in the form of computer-executable instructions suitable for execution by the processing unit(s) 922, 930. The memory 924 can also store footprint calculation data, a composite graph data structure, including nodes, edges, and their respective attributes; a table or other data structure indicating states of a modeled system, configuration data, UI displays, browser code, data structures including data tables, working tables, change logs, output structures, input fields, output fields, data values, indices, or flags, as well as other operational data.

A computing system 910 can have additional features, such as one or more of storage 940, input devices 950, output devices 960, or communication ports 970. An interconnection mechanism (not shown) such as a bus, controller, or network interconnects the components of the computing environment 910. Typically, operating system software (not shown) provides an operating environment for other software executing in the computing environment 910, and coordinates activities of the components of the computing environment 910.

The tangible storage 940 can be removable or non-removable, and includes magnetic disks, magnetic tapes or cassettes, CD-ROMs, DVDs, or any other medium which can be used to store information in a non-transitory way and which can be accessed within the computing environment 910. The storage 940 stores instructions of the software 980 (including instructions and/or data) implementing one or more innovations described herein.

The input device(s) 950 can be a mechanical, touch-sensing, or proximity-sensing input device such as a keyboard, mouse, pen, touchscreen, trackball, a voice input device, a scanning device, or another device that provides input to the computing environment 910. The output device(s) 960 can be a display, printer, speaker, optical disk writer, or another device that provides output from the computing environment 910.

The communication port(s) 970 enable communication over a communication medium to another computing device. The communication medium conveys information such as computer-executable instructions or other data in a modulated data signal. A modulated data signal is a signal that has one or more of its characteristics set or changed in such a manner as to encode information in the signal. By way of example, and not limitation, communication media can use an electrical, optical, RF, acoustic, or other carrier.

In some examples, computer system 900 can also include a computing cloud 990 in which instructions implementing all or a portion of the disclosed technology are executed. Any combination of memory 924, storage 940, and computing cloud 990 can be used to store software instructions and data of the disclosed technologies.

The present innovations can be described in the general context of computer-executable instructions, such as those included in program modules, being executed in a computing system on a target real or virtual processor. Generally, program modules or components include routines, programs, libraries, software objects, classes, components, data structures, etc. that perform tasks or implement particular abstract data types. The functionality of the program modules can be combined or split between program modules as desired in various embodiments. Computer-executable instructions for program modules can be executed within a local or distributed computing system.

The terms “system,” “environment,” and “device” are used interchangeably herein. Unless the context clearly indicates otherwise, none of these terms implies any limitation on a type of computing system, computing environment, or computing device. In general, a computing system, computing environment, or computing device can be local or distributed, and can include any combination of special-purpose hardware and/or general-purpose hardware and/or virtualized hardware, together with software implementing the functionality described herein. Virtual processors, virtual hardware, and virtualized devices are ultimately embodied in a hardware processor or another form of physical computer hardware, and thus include both software associated with virtualization and underlying hardware.

### Example Cloud Computing Environment

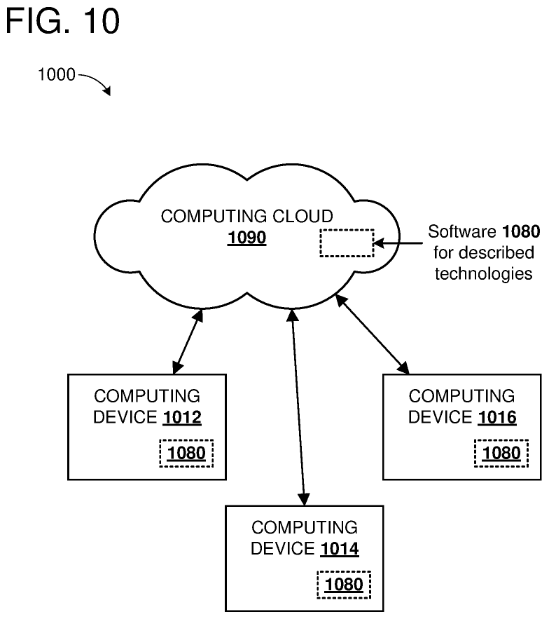

FIG. 10 depicts an example cloud computing environment 1000 in which the described technologies can be implemented. The cloud computing environment 1000 comprises a computing cloud 1090 containing resources and providing services. The computing cloud 1090 can comprise various types of cloud computing resources, such as computer servers, data storage repositories, networking resources, and so forth. The computing cloud 1090 can be centrally located (e.g., provided by a data center of a business or organization) or distributed (e.g., provided by various computing resources located at different locations, such as different data centers and/or located in different cities or countries).

The computing cloud 1090 can be operatively connected to various types of computing devices (e.g., client computing devices), such as computing devices 1012, 1014, and 1016, and can provide a range of computing services thereto. One or more of computing devices 1012, 1014, and 1016 can be computers (e.g., servers, virtual machines, embedded systems, desktop, or laptop computers), mobile devices (e.g., tablet computers, smartphones, or wearable appliances), or other types of computing devices. Communication links between computing cloud 1090 and computing devices 1012, 1014, and 1016 can be over wired, wireless, or optical links, or any combination thereof, and can be short-lived or long-lasting. Communication links can be continuous or sporadic. These communication links can be stationary or can move over time, being implemented over varying paths and having varying attachment points at each end. Computing devices 1012, 1014, and 1016 can also be connected to each other.

Computing devices 1012, 1014, and 1016 can utilize the computing cloud 1090 to obtain computing services and perform computing operations (e.g., data processing, data storage, and the like). Particularly, software 1080 for performing the described innovative technologies can be resident or executed in the computing cloud 1090, in computing devices 1012, 1014, and 1016, or in a distributed combination of cloud and computing devices.

### General Considerations

As used in this disclosure, the singular forms “a,” “an,” and “the” include the plural forms unless the surrounding language clearly dictates otherwise. Additionally, the terms “includes” and “incorporates” mean “comprises.” Further, the terms “coupled” or “attached” encompass mechanical, electrical, magnetic, optical, as well as other practical ways of coupling items together, and does not exclude the presence of intermediate elements between the coupled items. Furthermore, as used herein, the terms “or” and “and/or” mean any one item or combination of items in the phrase.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media, such as tangible, non-transitory computer-readable storage media, and executed on a computing device (e.g., any available computing device, including tablets, smartphones, or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example, and with reference to FIG. 6, computer-readable storage media include memory 624, and storage 640. The term computer-readable storage media does not include signals and carrier waves. In addition, the term computer-readable storage media does not include communication ports (e.g., 670) or communication media.

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network, a cloud computing network, or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in ABAP, Adobe Flash, Angular, C, C++, C#, Curl, Dart, Fortran, Go, Java, JavaScript, Julia, Lisp, Matlab, Octave, Perl, Python, R, Ruby, SAS, SPSS, WebAssembly, any derivatives thereof, or any other suitable programming language, or, in some examples, markup languages such as HTML or XML, or in any combination of suitable languages, libraries, and packages. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, infrared, and optical communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub-combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A computer-implemented method comprising:
receiving activity data for an organization;
determining emissions factors for the activity data;
calculating absolute and relative sustainability footprints associated with operations of the organization based on the activity data and the emissions factors;
calculating average relative sustainability footprints for the organization over a specified time period based on the absolute and relative sustainability footprints; and
generating, for display on a graphical user interface, an indication of the absolute, relative, and average relative sustainability footprints.

2. The computer-implemented method of claim 1, wherein the activity data includes inflow and outflow materials.

3. The computer-implemented method of claim 1, wherein the emissions factors are determined based on information received from an external factors provider or a supplier.

4. The computer-implemented method of claim 3, wherein the emissions factors are retrieved via execution of an Application Programming Interface (API) call.

5. The computer-implemented method of claim 1, wherein the calculated absolute, relative, or average relative sustainability footprints are stored in a multidimensional data cube.

6. The computer-implemented method of claim 5, wherein the calculated absolute, relative, or average relative sustainability footprints have object types and time as dimensions.

7. The computer-implemented method of claim 1, wherein the calculated absolute, relative, or average relative sustainability footprints are provided to one or more computer applications of an Enterprise Resource Planning (ERP) system for adjusting operations of the ERP system to reduce an overall footprint associated with operations managed by the ERP system.

8. The computer-implemented method of claim 1, wherein the activity data is aggregated for targeted time intervals to generate periodic aggregated activity data, and wherein the average relative sustainability footprints are calculated using the periodic aggregated activity data.

9. The computer-implemented method of claim 1, wherein calculating absolute and relative sustainability footprints includes calculating absolute and relative sustainability footprints for one or more of inflow materials, outflow materials, and materials accumulated in an inventory of the organization.

10. The computer-implemented method of claim 9, wherein the absolute and relative sustainability footprints for the outflow materials for a current period are calculated based on an associated relative sustainability footprint for a previous period.

11. The computer-implemented method of claim 1, wherein calculating absolute and relative sustainability footprints includes calculating absolute and relative sustainability footprints associated with purchasing and sourcing materials, manufacturing and maintenance of a production process associated with the materials, and transporting the materials.

12. The computer-implemented method of claim 1, wherein the calculation of the average relative sustainability footprints is triggered responsive to determining that the absolute and relative sustainability footprints corresponding to all of the activity data for a targeted period has been successfully calculated.

13. One or more computer-readable media storing instructions which, when executed by one or more hardware processors, cause the hardware processors to perform actions comprising:
retrieving a set of emissions factors relating to one or more products;
receiving activity data, the activity data including one or more categories of data relating to operations of an organization;
for each category of activity data, computer processing the activity data including mapping the activity data to a respective relevant emissions factor from the retrieved set of emissions factors to generate augmented activity data;
calculating, with the hardware processors, a plurality of relative sustainability footprints using the augmented activity data in association with operations during a period;
calculating an absolute sustainability footprint corresponding to a sum of the plurality of relative sustainability footprints for the period;
calculating, with the hardware processors, an average relative sustainability footprint based on the absolute and relative sustainability footprints; and
generating, for display via one or more views of a graphical user interface of a computer device, an indication of the calculated relative, absolute, and average relative sustainability footprints.

14. The one or more computer-readable media of claim 13, wherein the retrieved set of emissions factors includes sustainability reference content uploaded or defined by a user.

15. The one or more computer-readable media of claim 13, wherein the retrieved set of emissions factors includes sustainability reference content provided by a supplier or third party source.

16. The one or more computer-readable media of claim 13, wherein the retrieved set of emissions factors is selected by a user from a user interface, the user interface including a plurality of candidate sets of emissions factors, each candidate set of emissions factors comprising a table of emissions factor data with a different respective level of granularity corresponding to associations of one or more of products, suppliers, supplier region, or receiving region with emissions factors.

17. A system comprising:
one or more hardware processors with memory coupled thereto;
computer-readable media storing instructions executable by the one or more hardware processors, the instructions comprising:
first instructions to receive, via a graphical user interface displayed on a client computing device, a selection of emissions factors to be used for a sustainability calculation for an organization;
second instructions to receive activity data for the organization in accordance with one or more parameters of the calculation;
third instructions to calculate, for a first time period, relative and absolute footprints for the activity data associated with the first time period using the emissions factors;
fourth instructions to calculate, for a second, subsequent time period, relative and absolute footprints for the activity data associated with the second time period, wherein the calculation of the relative and absolute footprints for outflows use an associated relative or absolute footprint calculated for the first time period;
fifth instructions to calculate an average relative footprint based on the calculated relative and absolute footprints; and
sixth instructions to output an indication of the calculated average relative footprint to one or more computer applications of the system for adjusting operations of the system to reduce an overall footprint associated with the organization.

18. The system of claim 17, wherein one or more of the activity data and the emissions factors are provided by a cloud-based computing system.

19. The system of claim 17, wherein the one or more applications include one or more applications of an Enterprise Resource Planning (ERP) system.

20. The system of claim 17, wherein the instructions further comprise seventh instructions to output the indication of the calculated average relative footprint or the relative and absolute footprints for the first or second time periods to the graphical user interface for display to a user.
